(19) United States
(12) Patent Application Publication
(10) Pub. No.: US 2025/0231772 A1
(43) Pub. Date: Jul. 17, 2025

(54) PRODUCT DEVELOPMENT SYSTEM, SIMULATIONS, EMULATIONS, AND METHODS FOR RAPID TEST AND DEPLOYMENT FOR REMOTELY CONTROLLED MACHINES

(71) Applicant: MoonTower Analytics LLC, Austin, TX (US)

(72) Inventor: Craig Nehrkorn, Austin, TX (US)

(21) Appl. No.: 19/017,317

(22) Filed: Jan. 10, 2025

Related U.S. Application Data
(60) Provisional application No. 63/620,141, filed on Jan. 11, 2024.

(51) Int. Cl. G06F 9/445

(52) U.S. Cl. CPC G06F 9/44521

(57) ABSTRACT

A rapid system development platform may provide for the ability to rapidly develop a remotely controlled and/or autonomously operated system, such as an unmanned aerial vehicle (e.g., drone), mobile robot, stationary robot, or other system. The platform may support database(s) that provide for equipment, such as hardware electronic and electrical components, to be selectable for inclusion with the system. The electronic equipment, for example, may include an electronic control unit (ECU) that is preconfigured to be utilized on a common bus and communicate with other electronic components selectable to be included on the system. The platform may support preconfigured software and/or firmware for downloading to the electronics to be executed thereby. The platform may provide one or more application programming interfaces (APIs) for supporting the system along with dashboard(s) that are preconfigured based on the type of system and data being communicated by the system.

### RELATED APPLICATIONS

This application claims priority to co-pending U.S. Provisional Patent Application having Ser. No. 63/620,141 filed on Jan. 11, 2024; the contents of which are hereby incorporated by reference in their entirety.

### BACKGROUND

Developing remotely controlled and/or autonomously operated systems is generally a challenging effort for a number of reasons, including, but not limited to, having to create tools for use in developing, testing, and operating such systems. Remotely controlled and/or autonomously operated systems may be considered Internet-of-things (IoT) systems as remotely controlled and/or autonomously operated systems may collect and generate various information for a wide variety of purposes. However, as engineers in the field of robotics, drones, and other remotely controlled and autonomously operated systems can attest, the development process is extremely time-consuming and engineering effort is rigorous as a result of having to create a full end-to-end solution that includes developing electrical and electronic hardware, software, and firmware irrespective of the type of platform (e.g., land-based, sea-based, aerial-based, space-based, etc.). As such, there is a need to reduce the amount of time and cost in developing, testing, and operating the systems.

Moreover, before deployment of such remotely controlled and/or autonomously operated systems, simulation and physical testing must be performed. Tools for performing simulation and physical testing of systems often take as much time or longer to develop as development of the system itself. Simulations enable development engineers to test system operations virtually (i.e., in software) to ensure stability and functionality of the systems, and physical test systems enable physical testing of the systems to confirm how an actual system operates to confirm system operation and safety before deployment. Development of such testing generally requires a team of engineers due to complexity thereof. As such, there is a need to reduce the amount of time and cost in developing simulations and physical test systems to test remotely controlled and/or autonomously operated systems.

In addition to the extensive cost of developing and testing systems prior to deployment of a system, an operational platform to support an operator in operating remotely controlled and/or autonomously operated systems is needed. The operational platform may range from a handheld controller (e.g., remote controller) to a fully integrated network operations center (NOC) at which operators may control and monitor the systems, manage and view collected and generated data, and so on. Developing an operational platform may be as challenging and time consuming as developing the system and test system. As such, there is a need to reduce the amount of time and cost in developing operational platforms for remotely controlled and/or autonomously operated systems.

### BRIEF SUMMARY

To overcome the lack of existing development platforms for developing, testing, and operating remotely controlled and/or autonomously operated systems, such as robotics, drones, and other land-based or non-land-based systems, the principles described herein provide for a rapid system development platform that includes control hardware, including an electronic control unit (ECU), software, and firmware for a developer and operator to utilize. The rapid system development platform may include a user database, equipment database, command and control signal software, and firmware files. The hardware and software development tools may be readily utilized by development engineers to rapidly develop and deploy remotely controlled and/or autonomously operated systems. The hardware and software may be preconfigured to work with one another utilizing application programming interfaces (APIs) and other tools to reduce or eliminate development time. In addition, administration tools and preconfigured data processing tools and dashboards may be provided to access captured and generated telemetry or Internet-of-Things (IoT) data for operators of the systems developed using the rapid system development platform. By providing the development system and deployment tools (e.g., pre-configured administration, telemetry, and operation/testing dashboards), development engineers can rapidly develop remotely controlled and/or autonomously operated systems, test systems, and deployment platforms.

To enable the development engineer to simulate and test the systems, simulation and test tools that are pre-configured to operate with components (e.g., electronic control unit (ECU), software, databases, etc.) used in developing a remotely controlled and/or autonomously operated system may be made available by a platform provider, thereby supporting a developer in simulating, emulating, rapid prototyping, testing, and deploying a remotely controlled and/or autonomously operated systems. As a result of the development, deployment, simulation, and test tools, systems may be developed and produced in significantly shorter timeframes and with significantly less cost than previously possible.

One embodiment of a rapid system development platform for developing and operating a remotely controlled and/or autonomously operated system may include a non-transitory storage device configured to store: (i) a user database, (ii) available hardware components database, including: at least one electronics control unit (ECU), (b) at least one companion computer, (c) at least one battery management unit, (d) at least one motion management unit, and (e) at least one radio configured to communicate data captured or generated by the remotely controlled and/or autonomously operated system. The non-transitory storage device may further be configured to store (iii) a software and firmware database configured to be downloaded into a remotely controlled and/or autonomously operated system that includes at least one component provided in the available components database that utilizes software and/or firmware. The system may include at least one cloud server configured to execute at least one application programming interface (API) pre-configured to receive data from the at least one radio, and at least one dashboard configured to be executed on a computing device in communication with the at least one cloud server, and pre-configured to display data received via the at least one API.

One embodiment of a remotely controlled and/or autonomously operated system may include an electronic control unit (ECU) configured to manage operations of the system. The system may include at least one sensor. A companion computer may be in electrical communication with the ECU and be configured to process signals output by the sensor(s). A drive management unit may be in electrical communication with the companion computer and configured to manage movement of the system. A battery management system may be in electrical communication with the ECU and configured to manage operations of the at least one battery. A radio unit may be in electrical communication with the ECU. A communications bus via which the ECU, companion computer, drive management unit, battery management unit, and radio unit communicate with one another may be included.

One method of manufacturing a remotely controlled and/or autonomously operated system may include selecting an electronic control unit (ECU) configured to manage operations of the system. At least one sensor, companion computer, drive management unit, at least one battery, battery management unit, radio unit, and at least one actuator may be selected. The ECU, sensor(s), companion computer, drive management unit, battery(s), battery management unit, radio unit, and actuator(s) may be assembled on a chassis of the system. Software and/or firmware to be executed by at least one of the ECU, companion computer, and drive management unit of the system may be selected, and the selected software and/or firmware may be downloaded to the at least one of the ECU, companion computer, and drive management unit to be executed thereby.

One embodiment of a rapid system development platform may be configured to develop a remotely controlled and/or autonomously operated system. The system may include a non-transitory device configured to store preconfigured data repositories, including: (i) a user database, (ii) equipment database, and (iii) command/control data associated with the equipment database. A transceiver may be configured to communicate and receive commands and/or data with the remotely controlled and/or autonomously operated system. At least one processor may be in communication with the non-transitory storage device and the transceiver, and be configured to provide a user interface that enables a user to (i) submit a user identification, (ii) select preset equipment data associated with the remotely controlled and/or autonomously operated system, and (iii) communicate command/control signals to the remotely controlled and/or remotely operated system via the transceiver.

### BRIEF DESCRIPTION OF THE DRAWINGS

Illustrative embodiments of the present invention are described in detail below with reference to the attached drawing figures, which are incorporated by reference herein and wherein:

FIG. 1A is an image of an illustrative unmanned aerial vehicle (UAV), such as a drone, that may be remotely controlled and/or autonomously operated and configured with development hardware, software, and/or firmware utilizing a rapid system development platform according to the principles described herein;

FIG. 1B is an image of an illustrative robot that may be remotely controlled and/or autonomously operated and configured with development hardware, software, and/or firmware utilizing a rapid system development platform according to the principles described herein;

FIG. 2 is an illustration of an illustrative control station or network operations center (NOC) configured by a rapid system development platform that includes a remote controller and onboard electronics (e.g., ECU, radio, software, firmware, etc.) and is used to control and/or monitor a remotely controlled and/or autonomously operated system, such as a drone;

FIG. 3 is an illustration of an illustrative end-to-end system for operating a remotely controlled and/or autonomously operated system utilizing the principles described herein;

FIGS. 4A and 4B are block diagrams of illustrative high-level and detailed schematics of a remotely controlled and/or autonomously operated system utilizing the principles described herein;

FIG. 5 is a block diagram of illustrative ECU modules configured to manage subsystems operating on a remotely controlled and/or autonomously operated system utilizing the principles described herein;

FIG. 6 is a block diagram of illustrative preconfigured tools of a rapid system development platform for a development engineer to develop a remotely controlled and/or autonomously operated system, simulation, test, and deployment systems;

FIG. 7 is an illustration of illustrative downloadable tools for a rapid system development platform including a development station that enables a development engineer to select software and firmware to install on a remotely controlled and/or autonomously operated system (e.g., drone) based on a structure and function of the system, such as an ECU and other hardware selected to be utilized to operate in the system;

FIG. 8 is a flow diagram of an illustrative process supported by a rapid system development platform for enabling a development engineer to select hardware and present software and firmware associated with the selected hardware that may be downloaded;

FIG. 9 is a block diagram of an illustrative software simulator and hardware emulator provided as part of a rapid system development platform to enable a development engineer to simulate and emulate the hardware, software, and/or firmware selected to develop a remotely controlled and/or autonomously operated system;

FIG. 10 is an illustration of an illustrative rapid development platform or kit inclusive of a simulator/emulator system along with a system test area to test a remotely controlled and/or autonomously operated system developed thereby; and

FIG. 11 is a block diagram of an illustrative system architecture that supports software and firmware storage, and data flows utilizing the system architecture that are part of a rapid system development platform.

### DETAILED DESCRIPTION OF THE DRAWINGS

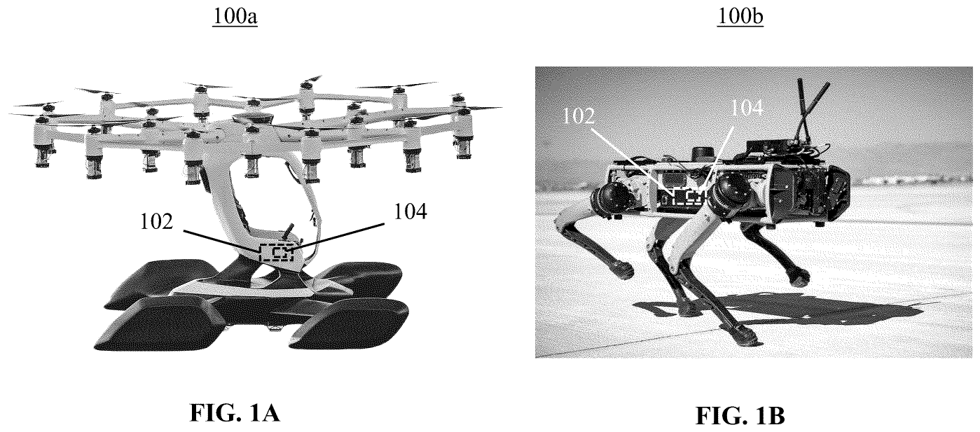

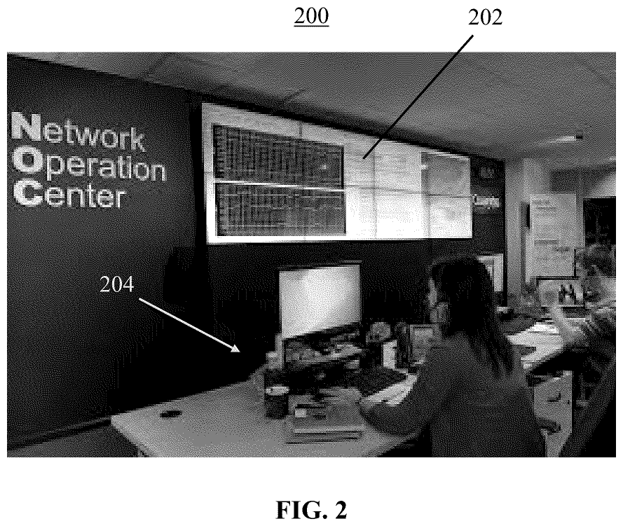

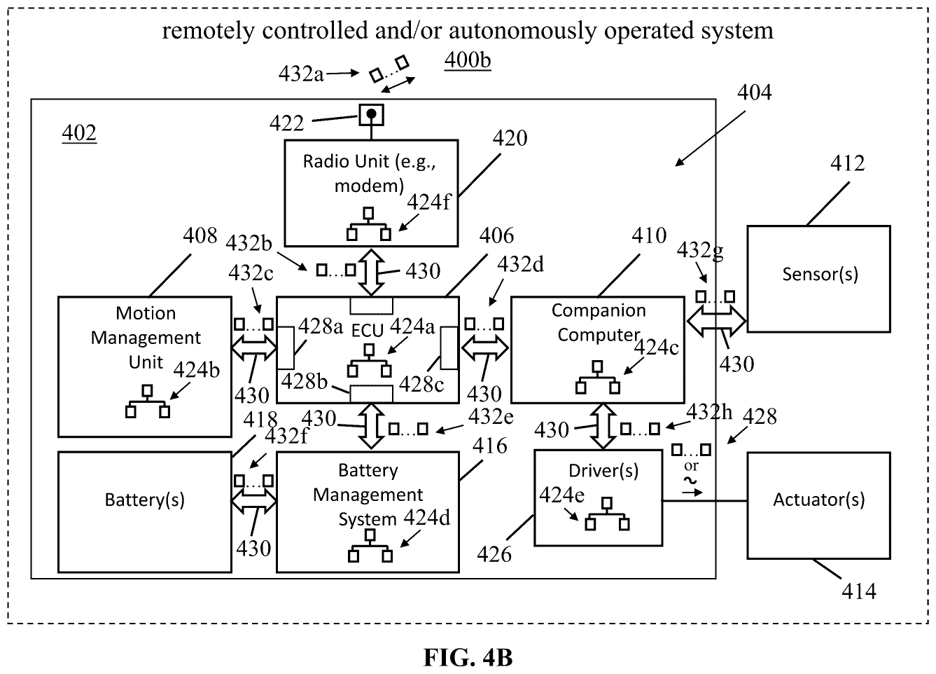

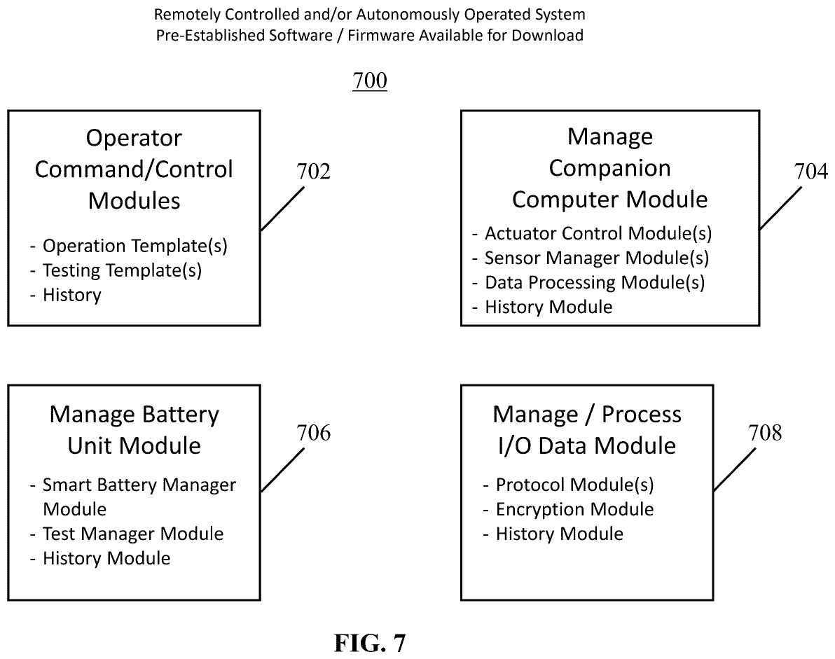

With regard to FIG. 1A, an image of an illustrative unmanned aerial vehicle (UAV) 100a, such as a drone, that may be remotely controlled and/or autonomously operated is shown. The UAV 100a may be configured with electronics 102, which may include development hardware, software, and/or firmware made available by a rapid system development platform, according to the principles described herein. The electronics 102 may include an electronic control unit (ECU) 104 and other supporting electronics (see, for example, FIG. 4) that enable a development engineer to rapidly develop and test the UAV 100a. The ECU 104 may be configured to control operations of the UAV 100a by use of available software and firmware from the rapid system development platform (see, for example, FIG. 7). The ECU 104 may include one or more processors that control the UAV 100a by interacting with (i) one or more companion computers (see, FIG. 4), (ii) electromechanical systems, devices, and/or other components that are used to control flight of the UAV 100a, (iii) imaging by the UAV 100a, (iv) collection and communication telematics, and (v) any other function performed by the UAV 100a. The ECU 104 may be configured to operate in multiple modes, such as simulation mode, emulation mode, test mode, and operational mode. If the UAV 100a is configured with a weapon, for example, then the ECU 104 may be configured to operate the UAV 100a in a “safe” mode or “armed” mode. Other functions and modes may be utilized depending on a type of UAV in which the electronics 102 with the ECU 104 is operating. The UAV 100a may be any of single-rotor, multi-rotor, fixed-wing, or hybrid UAV 100a. Rather than being a UAV 100a, per se, the electronics 102 and ECU 104 may be integrated into a rocket, in which case a rocket engine and various safety measures that are consistent with managing and operating rocket engines may be supported by the electronics 102 and ECU 104.

With regard to FIG. 1B, an image of an illustrative robot 100b that may be remotely controlled and/or autonomously operated and configured with the same or similar electronics 102 with the electronic control unit (ECU) 104 including development hardware, software, and/or firmware made available by a rapid system development platform, according to the principles described herein is shown. It should be understood that a robot configured to operate in any other land-based, sea-based, space-based, or any other environment (e.g., indoor, subterranean, sub-sea, etc.) and perform any function integrated into the robot is possible utilizing the electronics 102 and ECU 104 as supported by the rapid system development platform is contemplated herein.

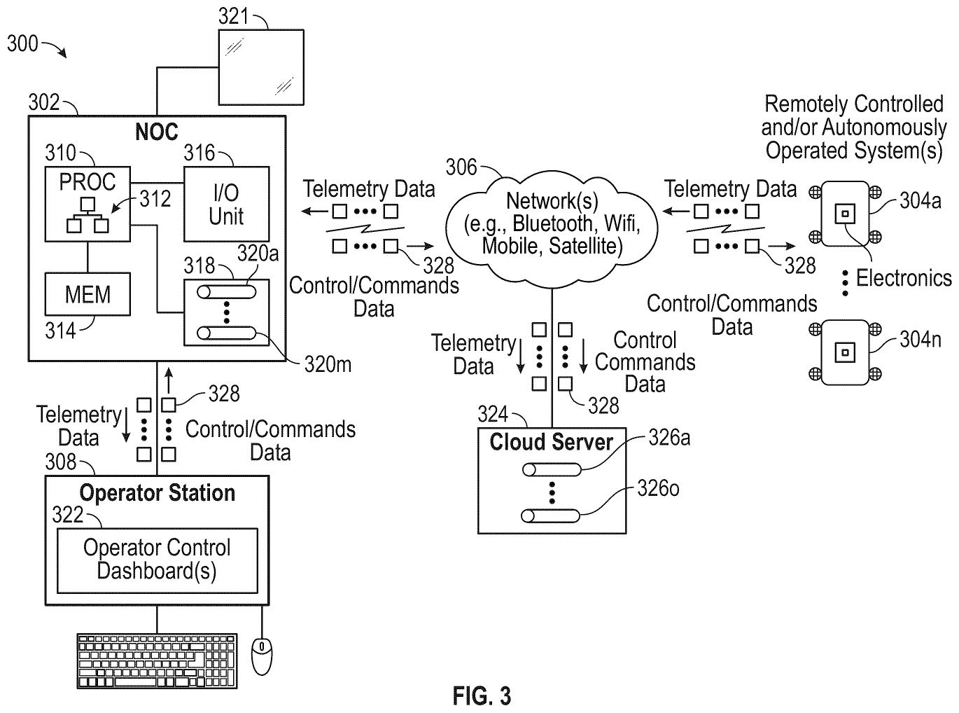

With regard to FIG. 2, an illustration of an illustrative control station or network operations center (NOC) 200 configured to utilize a rapid system development platform that includes a remote controller and onboard electronics (e.g., ECU, radio, software, firmware, etc.) used to control and/or monitor a remotely controlled and/or autonomously operated system is shown. The NOC 200 typically includes one or more electronic displays 202 for displaying operational data and includes operator station(s) 204 to be utilized for deployment and operational control of the system (e.g., drone). The NOC 200 may include any additional hardware and/or software so as to be configured to be utilized for any stage of development, test, or deployment.

In an embodiment, the NOC 200 may be configured with pre-defined user interfaces, such as one or more dashboards, control interface, video interface, etc., configured to access and display operational data in a preconfigured format. The operator station(s) 204 may include user interface devices, such as a keyboard, computer mouse, joystick, touch screen, and/or any other user interface device that enables an operator to operate the operator station(s) 204. The operator station(s) 204 may enable controlling the systems and accessing telemetry data, control data, and other data. For example, an operator may utilize the NOC 200 to display data collected from the system to enable the user or operator to view images (e.g., static images or sequence of images captured from a camera on the system), control motion of the system, control functional devices (e.g., landing gear, angles of rotary drives, etc.) of the system, and/or monitor or control any other functional feature integrated into the system. The NOC 200 may be part of the rapid development kit or be separately developed therefrom. For example, hardware, software, and/or firmware may be available from a provider of the platform, and the software and/or firmware may be downloadable onto the NOC 200. In an embodiment, software, such as APIs, translators, and/or other software for supporting telemetric data communications may be preconfigured to simplify and reduce development efforts. For example, APIs that are preconfigured to receive and process global positioning system (GPS) data may be readily available for a developer of the NOC 200. In either case, the NOC 200 may be capable of accessing and controlling pre-configured hardware, software, and/or firmware obtained from the platform, thereby enabling a seamless integration with the system (e.g., robot controlled by the NOC 200). The NOC 200 may have simulation, test, and operational modes, thereby supporting any or all stages of development and deployment.

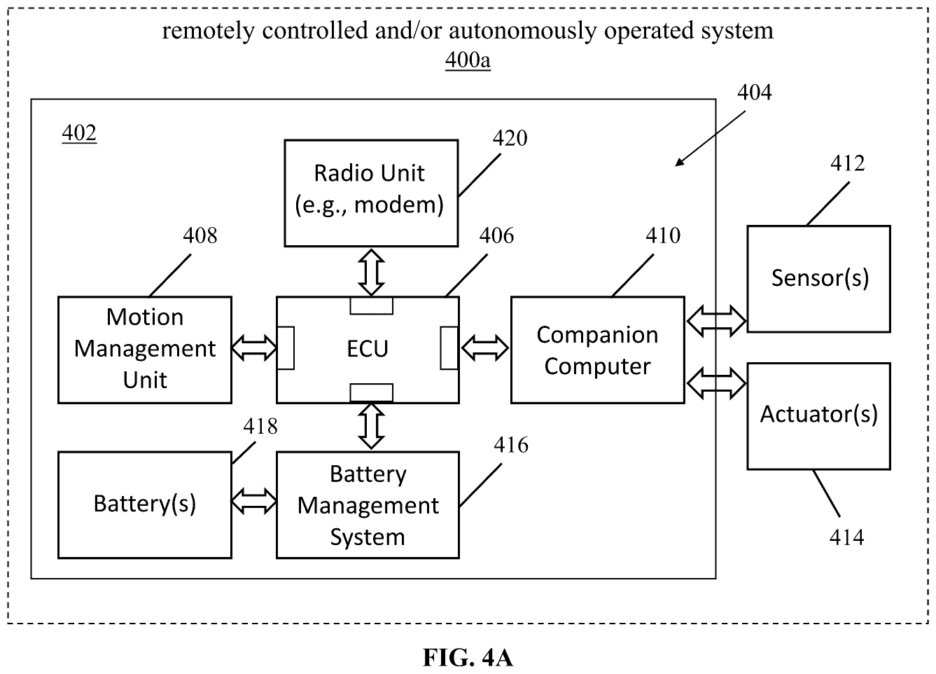

With regard to FIG. 3, an illustration of an illustrative end-to-end operational system 300 for operating a remotely controlled and/or autonomously operated system utilizing the principles described herein is shown. The system 300 may include a control and command or network operations system 302 configured to be in communication with one or more remotely controlled and/or autonomously operated systems 304a-304n (collectively 304), shown as unmanned aerial vehicles, via a network 306. The network 306 may include one or more types of communications channels, including a Bluetooth, WiFi®, mobile, satellite, Zigby®, radio frequency (RF), or any other wired and/or wireless communications networks. An operator station 308 may be in communication with the NOC 302 to enable an operator, such as a flight control operator or pilot, to operate and control the system(s) 304 after having been developed and deployed using a product development platform, as further provided herein. The operator station 308 may be any computer device, such as a desktop, laptop, tablet, smartphone, or any other handheld or non-handheld electronic device configured with one or more processors that may be local or cloud-based. In an embodiment, the rapid system development platform, as further described herein, may be utilized to create the end-to-end system 300 once configured by a development engineer.

As shown, the NOC 302 may include one or more processors 310 that execute software 312. If multiple processors 310 are utilized, functions supported by different software modules or code may be executed on the same or different processors 310. The processor(s) 310 may be in communication with a non-transitory memory 314, an input/output (I/O) unit 316 that includes one or more transceiver configured to utilize wireline and/or wireless communications protocols, and a storage unit 318, such as a disk drive and/or static non-transitory memory, configured to store one or more data repositories 320a-320m (collectively 320). The I/O unit 316 may be configured to support one or more application programming interfaces (APIs) so that a developer of the system(s) 304 may be able to incorporate corresponding API(s) onto the system(s) 304 or seamlessly communicate with the API(s). The data repositories 320 may further be configured to store software, control data, collected test data, operational data, and/or sensed data (raw and/or processed). The NOC 302 may further be in communication with one or more electronic displays 321 (see also display(s) 202 of FIG. 2) for displaying development and/or operational content. In an embodiment, data produced by the NOC 302 to control the system(s) 304 and received from the system(s) 304 may be stored in the data repository(s) 320. The software 312 executed by the processor(s) 310 may be configured to support the operator station 308, such as generating one or more operator dashboards 322 that enables the operator to perform control functions of the system(s) 304.

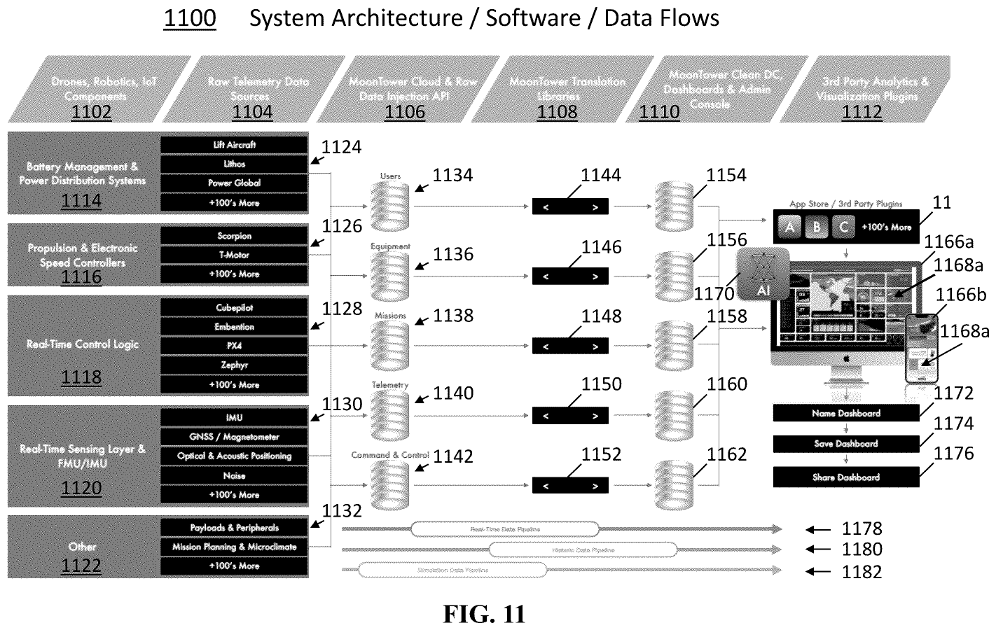

A cloud server 324 may be configured to store data repositories 326a-3260 (collectively 326) that may be configured to store software and/or firmware for inclusion when developing the system(s) 304, software of operation control dashboard(s) 322 for execution on the operator station 308, and so on, as further described herein. Data generated and/or collected by the systems 304 may also be stored in the data repository(s) 326 and accessed by the operator station 308 and/or NOC 302 during and after operation of the system(s) 304. In addition, the cloud server 324 may be configured to store development software and firmware, such as shown in FIGS. 7 and 11, to enable a development engineer more rapidly develop a remotely controlled and/or autonomously operated system and optionally simulation, emulation, test system, and/or operator station therefor. Still yet, one or more APIs and translation software may be supported by the cloud server 324. In an embodiment, the cloud server 324 may be configured to operate as a software-as-a-service (SAAS) to support development and/or operations for a development engineer and/or operator.

The control function(s) may include selecting one or more system(s) 304 to control, generate operations (e.g., flight commands) for the system(s) 304 to perform, and so on. If the system(s) 304 are configured to collect and communicate images (e.g., individual static or a sequence of static images (e.g., video)) and/or other data (e.g., operational data, such as speed, heading, altitude, GPS coordinates, battery life, etc.), as further described herein, the data and/or images may be displayed on one or more of the operator control dashboard(s) 322 so that the operator may view the images and/or data while controlling the system(s) 304. If the system(s) 304 are autonomously operated, then the operator may set up a plan or issue instructions for this system(s) 304 to perform (e.g., mow grass between mile markers 12 and 14; capture images and sense temperatures of solar panels along rows 25 and 32 of a solar farm at geographical coordinates (AZ, EL), etc.). Many other examples of autonomous robots and machines, including stationary robots, and functions to be performed by the robots may utilize the principles described herein.

In operation, an operator may utilize the operator station 308 to control the system(s) 304 the operator control dashboard(s) 322 to select functions for the systems 304 to perform and generate control/commands data 328 that are communicated to the NOC 302, which may further communicate the control/commands data 328 via the network(s) 306 to the system(s) 304. If a cloud server 324 is utilized, the control/commands data 328 may be communicated thereto and stored in the data repository(s) 326 so that historical information may be stored. Although the end-to-end system 300 shows the operator station 308 communicating via the NOC 302, it should be understood that the operator station 308 may be configured to communicate directly or indirectly with the network(s) 306, system(s) 304, and/or cloud server 324 independent of the NOC 302.

With regard to FIGS. 4A and 4B, block diagrams of illustrative high-level schematics of a remotely controlled and/or autonomously operated system 400a and 400b utilizing the principles described herein are shown. The system 400a may be configured with one or more printed circuit boards 402 inclusive of electronic and electrical components 404 that are specified to operate with a rapid system development kit or platform that assists a development engineer to rapidly develop remotely controlled and/or autonomously operated systems. The printed circuit board(s) 402 may be available as part of the rapid system development kit that is fully or partially populated with the electronic and electrical components 404. In an embodiment, a provider of the rapid system development kit may provide fully populated, partially populated, and/or unpopulated printed circuit board(s) 402. Still yet, the provider may offer custom printed circuit board(s) 402 that are configured with specific electronic and electrical components 404 per specific orders from development engineers. In other words, a variety of different electronic and electrical components 404 may be made available for development engineers to select for populating the printed circuit board(s) 402. However, the specific types (e.g., makes and models) of electronics and electrical components may vary, but perform the same or similar functions depending on the type and configuration of system being developed.

In an embodiment, a development engineer may select the various electronic and electrical components 404 and utilize the rapid system development kit for the development process, as further described herein. Because systems, such as drones, robots, or otherwise, have a wide range of sizes and shapes, there may be standard configurations of the PCB(s) 402 for development engineers to purchase, but also customized PCB(s) 402 to purchase. Moreover, although the PCB(s) 402 do not show all of the electronic and electronic components 404 to be on a single PCB, it should be understood that different PCBs may have different electronic and electrical component(s) disposed thereon so as to fit particular size and shape profiles of the system in which the PCBs 402 are installed. In other words, because chassis of systems have a wide range of sizes and shapes, the electronics, electrical components, and circuit boards that support the electronics and electrical components may be sized and shaped to fit onto the chassis and into a housing of the system 400a being developed.

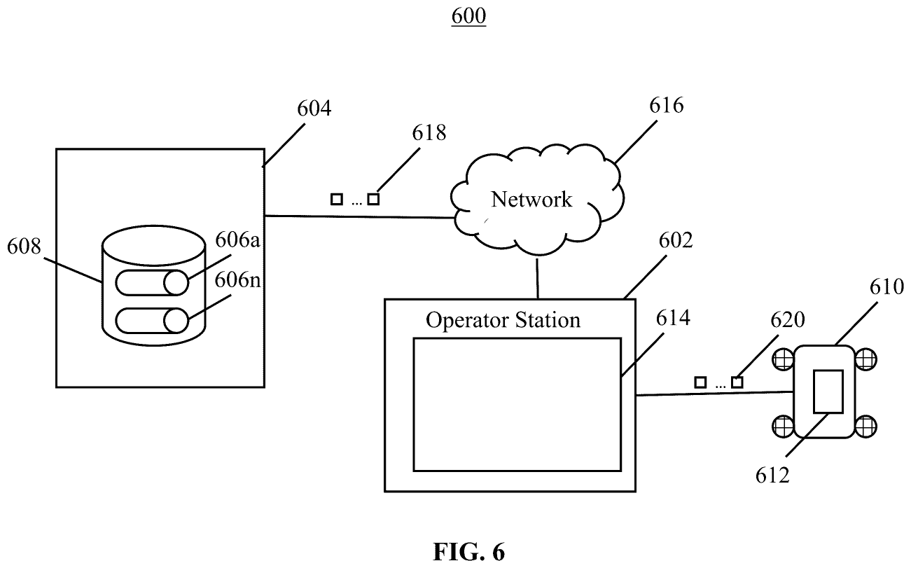

The electronics 404 may include an electronic control unit (ECU) 406, motion management unit 408, companion computer 410, sensor(s) 412, actuator(s) 414, battery management system 416, battery 418, and modem 420. The ECU 406 may be utilized to control various other electronics and electrical component functions to orchestrate or manage operations of the system 400a. The ECU 406 may be electronics disposed on a customized printed circuitry board (PCB) and include one or more processors that may be pre-programmed by the provider of the rapid system development kit and/or be programmable by a development engineer. In an alternative embodiment, the ECU 406 may be an application specific integrated circuit (ASIC) with circuitry configured to perform the functionality described herein. If pre-programmed, the program(s) may provide various software components for management of specific or generic other electronic and/or electrical components 404. For example, the pre-programmed software may include an operating system and software that anticipates the use of the motion management unit 408, companion computer 410, battery management system 416, and modem 420, either specific devices or generic devices. The software may enable the development engineer to enter parameters or modify source code of the software. As described with regard to FIGS. 6 and 11, the software may be selectable by the development engineer and downloaded to the ECU 406 and other electronic devices on the system 400a. In an embodiment, one or more APIs may be available for download and execution by the ECU 406, thereby simplifying communications of commands and data, such as telemetry data captured by the system 400a.

The motion management unit 408 may be configured to manage motion of the system 400a. For example, the motion management unit 408 may include one or more processors configured to manage flight paths, trajectories, arm movements, and/or other motions of the system 400a. The motion management unit may, for example, execute an automatic controller, guidance system, autopilot, and/or any other function. Control and/or other data produced by the motion management unit 408 may be communicated to the ECU 406 or directly or indirectly to other component(s), such as the companion computer 410, modem 420, and/or actuator(s) 414 to propel a system.

The companion computer 410 may include one or more processors configured to execute software for performing a number of different processes. The processors of the companion computer 410 may include one or more general purpose processors, controllers, image processors, signal processors, and controlling the actuator(s) 414, so on. The companion computer 410 may perform processes, such as sensing, processing captured data, and so on. In an embodiment, the software and/or firmware to be executed by the companion computer 410 may be available on the rapid system development platform and be downloadable to the system therefrom.

With regard to FIG. 4B, a more detailed block diagram of a remotely controlled and/or autonomously actuated system 400b. The system 400b is a more detailed schematic than that of the system 400a of FIG. 4A. As shown, the radio unit 418 may be in electrical communication with an antenna 420 for communicating signals 422 to and from the system 400b. The signals 422 may include commands to control the system 400b and data used as part of the control (e.g., geographic coordinates). The signals 422 may also include data collected or generated by the system 400b and sent to a NOC (e.g., NOC 200 of FIG. 2) or other system for processing and storing. The signals 422 may be communicated utilizing any communications protocol, as understood in the art.

The electronic components that include processor(s) or other processing components (e.g., application specific integrated circuits (ASICs), digital signal processors, image processors, etc.) that are capable of executing software may have software 424a-424f (collectively 424) and/or firmware downloaded thereto. In an embodiment, the software may be communicated to the system 400b, and the software may be downloaded to the associated electronic devices. The software 424 may be communicated wirelessly via the antenna 422 or via a wired connection, such as a fixture with one or more electrical connectors, wire with an electrical connector, or otherwise to a reciprocal connector on the system 400b. As previously described, the software 424 may be downloadable from a data repository on a web server or otherwise. The software 424 may be preconfigured to perform a number of different functions based on type (e.g., UAV, robot, mobile, stationary, etc.) of the system 400b.

The ECU 406 may include one or more processors that execute software 424a for managing the system 424a and communicate with the other electronics. Software 424b may be executed by the motion management unit 408 and may include parameters that may be used to control various motion (e.g., speed, stability, autopilot, etc.). A design engineer may submit the parameters prior to or after downloading the software 424b into the system 400b. The companion computer 410 may include one or more processors that execute software 424c for use in processing data captured by the sensor(s) 412 and control the actuator(s) 414. Battery management system 416 may include one or more processors that execute software 424d that is used to manage and/or control operation of the battery(s) 418.

Drivers 426 may be used to drive the actuator(s) 414 may include one or more processors to execute software 424e. The drivers 426 may output control signals 428 in either digital and/or analog form depending on the type and configuration of the actuator(s) 414. For example, if the actuator(s) 414 include a direct current to alternating current (DC/AC) converters, then the control signals 428 may be digital. The radio unit 420 may include one or more processors that are configured to execute software 424f. The software 424f may be configured process information (e.g., control signals or data) to be formatted and communicated from or received by the system 400b.

In an embodiment, a user identifier, system identifier, and/or other identifier(s) may be stored by the ECU 406 or radio unit 420 so that the identifier(s) may be communicated with other data so that a remote system may associate the data communicated by the system 400b with other data stored in associated with the user or system. In an embodiment, the data 424f may include an API that is preprogrammed and configured to enable a remote system with corresponding software (e.g., another preprogrammed API) to readily communicate with the system 400b.

The ECU 406 may include ports 428a-428c (collectively 428) that are common ports for connecting to a common bus 430. In an embodiment, the common bus 430 may be a controller area network (CAN) bus. By using a common bus 430, development of the system 400b may be simplified and preconfigured software that is configured to communicate over the common bus may be downloaded and readily utilized and executed by the electronic devices.

In operation, there may be modes of operation of the system 400b, including development mode (e.g., when software and/or firmware are being installed in memories of the various electronics to control operation thereof), test mode (e.g., when the system is being full-up tested or portions are being exercised during simulation and/or emulation), during operation (e.g., when the system is being utilized for an intended purpose). During development mode, signals 432a in the form of digital packets, for example, may be communicated to and from the system 400b. The signals 432a may include software and/or firmware used to operate the system 400b. The software and/or firmware may be received and stored in memory of the associated portion of the electronics (e.g., ECU 406, motion management unit 408, companion computer 410, drivers 426, battery management unit 416, radio unit 420, or otherwise). In an embodiment, the signals 432a may be received by the antenna 422 and processed by the radio unit 420. Alternatively, the signals 432a may be received via a wired connection, optionally in communication with the radio unit 420, and processed thereby. The signals 432a may be communicated from the radio unit 420 via the common bus 430 to the ECU 406, which, if the signals are software and/or firmware, such as software 424a, encoded to be executed by the ECU 406, stored in memory (not shown) therein. Otherwise, if the software and/or firmware in the signals 432a are encoded to be executed by another portion of the system 400b (and denoted as such in the signals), then the software and/or firmware may be communicated and stored in the intended portion of the system 400b.

In the test or operation modes, the signals 432a may include command(s) and/or data for operating the system 400b. For example, the signals 432a may include commands to cause the system 400b to fly or drive to certain geographic locations, fly or drive at a certain speed, perform specific self-tests, or perform any other function for which the system 400b is configured to perform. The commands and/or data may be processed and stored or used to control the various portions of the electronics (e.g., companion computer 410, motion management unit 408, etc.) and used to control operations (e.g., increase speed or orientation of the actuators 414). The command(s) and/or data may be communicated to the other portions of the system 400b as signals 432c, 432d, 432e, 432f, 432g, and 432h.

Furthermore, during the test or operation modes, data captured by the sensor(s) 412 and used to control or generated by the actuator(s) 414 may be communicated as respective signals 432g and 428 that may optionally be processed by software 424c of the companion computer 410 and software 424 of the driver(s) 426. The captured (e.g., images, measurements, etc.) or generated data (e.g., motions, acceleration, etc.) may be used by the companion computer 410, motion management unit 408, or remote system (e.g., NOC 200 of FIG. 2) to monitor or manage test or operation of the system 400b. Additionally, signals 432e and 432f may be used to manage and monitor the battery(s) 418, such as charge, temperature, or otherwise. Because the software being executed by the various components may be preconfigured based on the type of system 400b, types of components (e.g., processors) of the various portions of the system 400b, or otherwise, the ability for the developer to simply download and execute. Also, because the platform may provide a common bus and electronics, software, and/or firmware that are configured to operate on the common bus, then ability to rapidly prototype, simulate, test, and operate is fast and seamless.

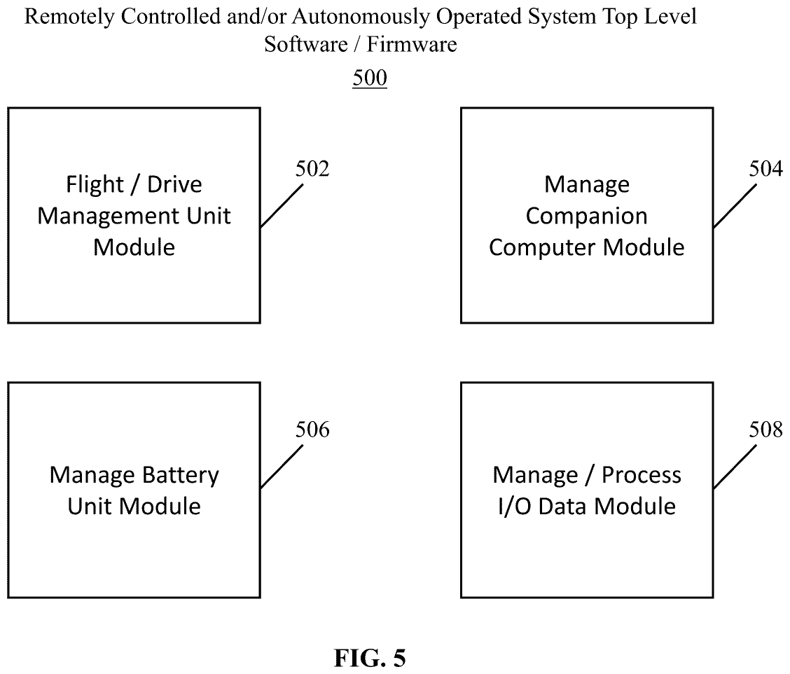

With regard to FIG. 5, a block diagram of illustrative ECU modules 500 configured to manage other subsystems operating on a remotely controlled and/or autonomously operated system, such as shown in FIG. 4A, utilizing the principles described herein is shown. The ECU modules 500 are top-level modules and/or firmware that may include a manage flight/drive management unit module 502 configured to manage flight or drive of the system. In managing the flight or drive of the system, the module 502 may be selectably configured by an engineer when setting up the system by submitting parameters (e.g., system is a UAV with fixed wings, system is a UAV with rotary propulsion, system is a UAV with jet engine(s), system is a ground vehicle with treads, system is a ground vehicle with wheels, system is to contain passengers, etc.). In an embodiment, a limited set of modules configured to support the submitted system parameter(s) may be automatically identified and downloaded or may be selected and downloaded by the engineer selecting specific module(s) that support a desired system profile, as is further described herein. The module 502 may be configured to manage a guidance system, autopilot, and any other modules for managing flight/drive of the system.

A manage companion computer module 504 may be executable instructions that, when executed by a processor, are configured to manage a companion computer configured to perform variety of different functions for operating the system. The different functions may be flight or drive related functions along with non-flight or non-drive related functions, such as capturing and processing data, performing collision avoidance functions, performing tracking functions, and/or otherwise.

A manage battery unit module 506 may be software configured to manage a battery. The module 506 may be used to monitor battery status, such as charge level, and further be configured to automatically charge a rechargeable battery when the system is connected to a rechargeable battery recharger. In an embodiment, if the battery charge becomes depleted, the module 506 may be configured to reduce energy usage of electrical components on the system. The module 506 may be configured to perform additional and/or alternative functions, as well.

A manage/process I/O data module 508 may be configured to manage data, such as data collected by sensors on the system. In an embodiment, the module 508 may be configured to manage or synchronize other modules that are processing the captured data and communicate raw and/or processed data to a remote server, for example. Depending on the nature of the data and operation being performed by the system (e.g., confidential or secret operation), the module 508 or other module managed by the module 508 may be configured to store the raw and/or processed data locally without communication from the system. The module 508 or another module managed by the module 508 may further be configured to store the raw and/or processed data in an encrypted or other format that is inaccessible without a digital key or other passcode.

It should be understood that the modules 500 are high-level and meant to control major functions of the system. It is possible that each of the modules 500 may be composed of or configured to manage many other modules that perform specific functions of components on the system. As described further herein, the specific modules may be pre-programmed and selectably available from a development platform (e.g., from a cloud-based data repository of the platform) that is used to enable an engineer to select and configure the system based on physical components, such as engines, motors, cameras, other sensors, drives, or otherwise operating on the system. Moreover, additional and/or alternative high-level modules may be utilized to manage major functionality of the system.

With regard to FIG. 6, an illustration of an illustrative rapid system development platform or kit 600 is shown. The rapid system development kit 600 may include an operator station 602 that may be used during development may be configured to enable a development engineer to access a server 604 that stores available resources (e.g., software and/or firmware) for remotely controlled and/or autonomously operated systems and support systems stored in data repositories 606a-606n (collectively 606) in an online storage unit 608 (e.g., disk drive, solid-state memory, or otherwise). The platform 600 may support electronics with an ECU, motion management system, companion computer, battery management system, radio or modem, and/or otherwise. The resources may be downloaded and installed on a remotely controlled and/or autonomously operated system (e.g., drone) 610 with electronics 612, including an ECU and supporting electronics. Selected resources may be based on an ECU and/or other hardware (see FIGS. 4A and 11, for example) selected to be utilized in the system 610. That is, the resources may be configured to support specific electronics 612 disposed on the system 610 (or on other systems), system types, electromechanical devices on the system 610 (or on other systems), etc., and may be selectable or automatically filtered in response to a development engineer submitting type of system and specific hardware disposed on the system.

As shown, the operator station 602 may display a user interface 614 that enables access to the server 604 to select resources stored in the data repository(s) 606. In an embodiment, the user interface 614 may enable the user to select or submit specific hardware (e.g., ECU, companion computer, etc.) being included in the system 610. In an alternative embodiment, the user interface 614 may display some or all available resources stored in the data repository(s) 606 for the development engineer to select for configuring the system 610. The resources may be increased and decreased depending on hardware that is available for inclusion in a remotely controlled and/or autonomously operated system.

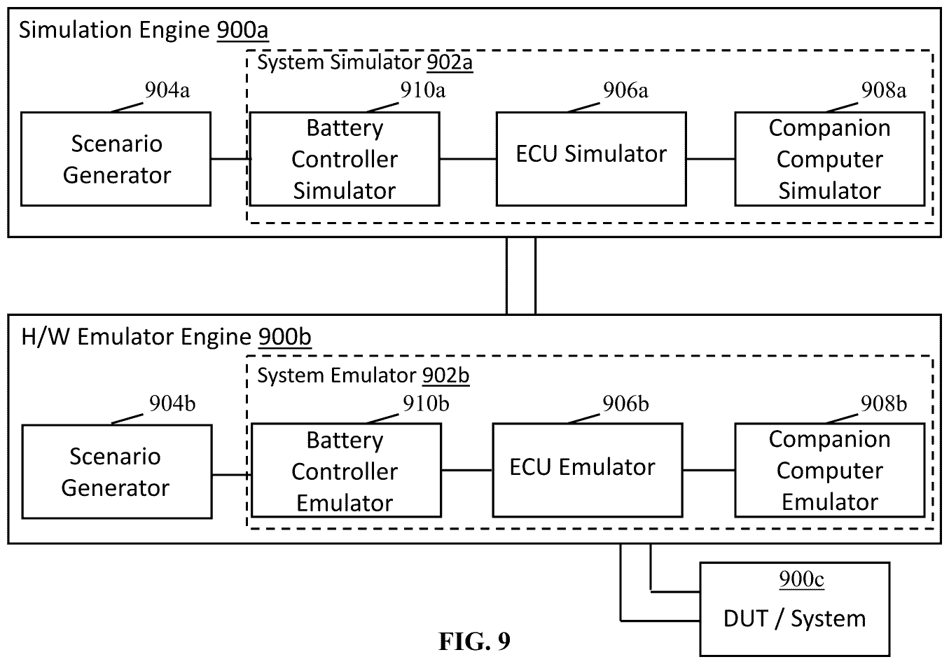

The operator station 602 may be in communication with the server 604 via network 616 such that the operator station 602 may request resources to be loaded into the system 610. Data 618 may be communicated between the operator station 602 and server 604 via the network 614 using any communications protocol, as understood in the art. The operator station 602 may download the resources (e.g., guidance system software) to be used for a simulation and/or emulation (see FIG. 9, for example) at the operator station 602 or to operate the system 610. In an embodiment, the operator station 602 may communicate the resources to the system 610 via a direct or indirect connection as data 620 for loading or updating the system 610 with the downloaded resources. The resources may be revised, updated, or otherwise populated with operational parameters (e.g., weights for control systems or geolocations for guidance systems). That is, a development engineer may utilize initial resource software code as a template and update or upgrade the resource software code for a particular purpose. The operator station 602 may provide for a simulation interface to utilize the resource(s) downloaded from the server 604, and optionally a hardware emulator to test the hardware and resource software code prior to installing in the system 610. In an embodiment, the emulator may include a chassis that enables hardware, such as a PCB to be installed in the system to be tested prior to installation in a system. In an alternative embodiment, the operator station 602 may be configured to request that the server 604 communicate the resources directly to the system 610 via a wired and/or wireless communication channel, and the operator station 602 may interface with the system 610 to update or populate parameters of the resources.

A supplier of the resources may provide a rapid system development platform or kit that includes the electronics 612, user interface 614 of the operator station 602, resources software code stored in the data repositories 606, and any other software, firmware, and/or hardware that enables a development engineer to rapidly develop a remotely controlled and/or autonomously operated system 610 and supporting systems (e.g., test system), as described herein. The operator station 602 or other system may be utilized to control or monitor the system 610. Data collected and/or processed by the operator station 602 may be communicated to the server or other cloud-based platform for storage of the collected and/or processed data in the data repository(s) 606.

With regard to FIG. 7, a block diagram of illustrative downloadable software tools or resources 700 for development engineers to utilize in developing a remotely controlled and/or autonomously operated system and supporting systems therefor is shown. The tools 700 may be preconfigured and stored on a local or cloud-based server (see FIG. 6, for example) so as to be available for the development engineers who use a rapid system development kit for developing remotely controlled and/or autonomously operated systems. The preconfigured tools 700 may include software modules and sub-modules associated with each of the software modules. That is, individual functions that are pre-configured for a development engineer to “plug-and-play” in an operation station, simulator, emulator, and/or a remotely controlled and/or autonomously actuated system may be provided. The sub-modules may cause hardware to perform specific functions. The sub-modules, while pre-programmed, may be configured with preset parameters or may prompt the development engineer to enter, select, or otherwise define the parameter(s) for a particular system being developed. Such parameter(s) may be based on type of system, available components (e.g., sensor(s), camera(s), motor(s), etc.) operating on the system, control system(s), guidance system (e.g., unmanned aerial vehicle, mobile robot, etc.), mapping function and/or global positioning system availability, and so on.

As shown, four tools 700 are provided. The tools 700 may include (i) operator command/control modules 702, (ii) manage companion computer module 704, (iii) manage battery unit module 706, and (iv) manage/process I/O data module 708. The modules 700 are illustrative and additional and/or alternative modules may be provided for a development engineer to utilize in rapidly developing a system. Moreover, the modules 700 are pre-configured to be downloaded to various components of a system, such as an ECU, companion computer, battery management circuit, operator station, simulator, emulator, test station, or otherwise.

The operator command/control modules 702 may provide for a number of pre-configured sub-modules, optionally including (i) operation template(s), (ii) testing template(s), and (iii) history. The operation template(s) sub-module may be software configured to generate and support a user interface of the operation station along with software configured to receive commands or instructions from the operation station by an operator. For example, the operation template(s) may enable the operator to enter a destination location, origination location, and/or flight path therebetween via the user interface of the operation station. In response, geocoordinates along with flight path waypoints may be generated and communicated to the system via a communications network. Corresponding software module(s) may receive the guidance and/or control instructions from the operator station and perform motions to achieve the desired trajectory.

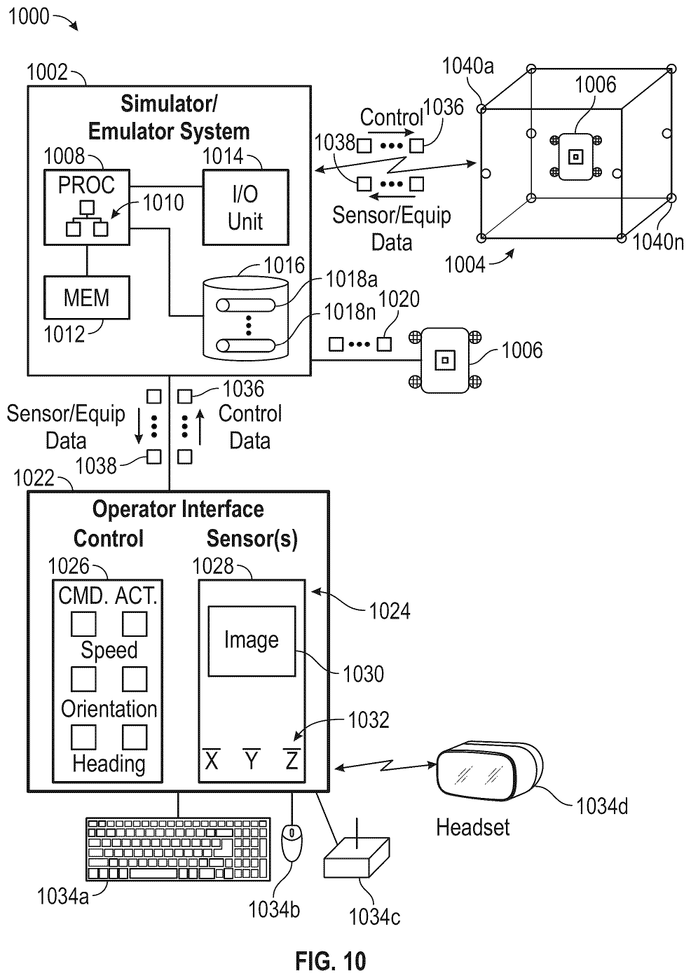

The testing template(s) may provide for testing by the operator station and/or corresponding testing system (see FIG. 10, for example) in which a system (e.g., robot, drone, etc.) may be tested. The testing template(s) may provide for a user interface to be displayed on the operator station (or other system) that enables the user to perform pre-determined and/or custom testing defined by a development engineer. The testing template(s) may support testing of individual components (e.g., motors, actuators, communications channels, etc.) on a system. The testing template(s) may include software that operates on the operator station, system, and/or test system, thereby providing for a full end-to-end testing platform for the rapid system development kit. As with other modules, the testing template(s) may provide default settings based on a type of system being developed, hardware included in the system, etc., and enable the development engineer to make specific changes to parameter settings. Moreover, the sub-modules may be provided as source code such that the development engineer may alter the code, as desired for a specific system, simulation, test system, etc.

The history sub-module may be configured to store history data collected and/or generated during simulation, testing, and/or operation. In an embodiment, the history sub-module may be configured to compare simulation results with operation results and generate statistics (e.g., difference over time, voltage comparison signals, power usage comparison, position differences, etc.). The history sub-module may also be configured to generate a user interface or portion thereof (e.g., frame on a larger user interface) that displays historical data, comparison data, and/or other data that helps an operator determine current performance versus historical performance. The history sub-module may further be configured to capture and/or process raw data on the system and collect and store the raw data and/or processed data by the operator station and/or data repository (e.g., cloud-based data repository).

The manage companion computer module 704 may be include a number of sub-modules for a development engineer to utilize in developing software for the companion computer on a system. The sub-modules may include actuator control module(s), sensor manager module(s), data processing module(s), and history module. It should be understood that additional and/or alternative modules may be utilized, such as guidance module, autopilot module, and so forth. In other words, any functions that may be performed by the companion computer of a system may be pre-configured to be downloaded and utilized by a development engineer.

The actuator control module(s) may be software configured to control actuators on the system. In an embodiment, the actuator control module(s) may enable an operator to select or enter specific actuators to be used on the system. For example, if the system is a UAV, specific motors for the rotors, motors for the gimbals of the rotors, motors for a camera or other sensor, and so on may be submitted by a development engineer for activation by the actuator control module. If the system is a robot or vehicle, then other actuators may be submitted to activate different actuator control functions (e.g., motor, steering motor, etc.).

Sensor manager module(s) may be software configured to manage one or more sensors on the system. In addition, the sensor manager module(s) may include software for managing sensor of a simulator, emulator, and/or test system. The sensor manager module(s) may be configured to control sensors (e.g., ON/OFF, position, zoom, focus, etc.) and control data captured by the sensor(s). In controlling the data, raw data may be received and stored locally or communicated to the operator station in real-time or non-real-time.

Data processing module(s) of the manage companion computer module 704 may be configured to process and/or communicate data captured by the sensor(s) of the system. The sensor data processing may be performed onboard the system, at the operator station, and/or on a cloud-based server. In an embodiment, the sensor data processing may be performed real-time, semi-real-time, and/or non-real-time. Depending on the sensor data, certain data may be processed real-time while other sensor data may be processed non-real-time. The module(s) may enable the development engineer to select a variety of different processing functions and processing times (e.g., real-time, non-real-time), frequencies (e.g., 1 KHz, 10 Hz, etc.), spectrums (e.g., infrared, ultraviolet, etc.), frequency ranges (e.g., 50 Hz-20 KHz), or otherwise. Moreover, the module(s) may allow for the development engineer to select specific makes and models of sensors, data types, and formats to be processed, stored, and communicated.

The history sub-module of the manage companion computer module 704 may be software that is configured to capture and store data from the sensor(s) (e.g., GPS coordinates, motor operation, collision, light detection and ranging (LIDAR), images, temperatures, etc.) for historical review, usage, and/or analysis.

The manage battery unit module 706 may include a number of different software sub-modules, including (i) smart battery manager module, (ii) test manager module, and (iii) history module. Each of the sub-modules may be executed by one or more processors on the system, operator station, test station, simulator, emulator, or combination thereof. The smart battery manager module may be configured to manage a rechargeable battery, such as optimizing usage by minimizing energy consumption of system components, performing charging of the rechargeable battery in an energy-efficient manner, or otherwise. The test manager module may be configured to manage testing of a system. In an embodiment, the test manager may enable a user to enter test parameters, test conditions, test ranges, Monte Carlo ranges, etc., to test the battery of the system. The test manager module may be configured to operate on the system, operator station, and/or test equipment. The history module of the manage battery unit module 706 may be configured to monitor battery usage, charge levels, recharging, etc., over time, process the data to determine health of a battery, change of battery conditions in different environments and over time, and perform other statistical analysis of the battery as operating within the system. It should be understood that the manage battery unit module 706 may include additional and/or alternative sub-modules for managing and tracking battery performance.

The manage/process I/O data module 708 may be configured to provide development engineers to readily support communications with a system during test and deployment of the system. The module 708 may include a number of software sub-modules, including (i) an encryption module and (ii) a history module. The encryption module may be configured to encrypt data prior to sending and/or storing the data depending on the nature of security desired for the system and data collection therefrom. The history module may be utilized to manage data collection history (e.g., by date, by mission, by data type, etc.).

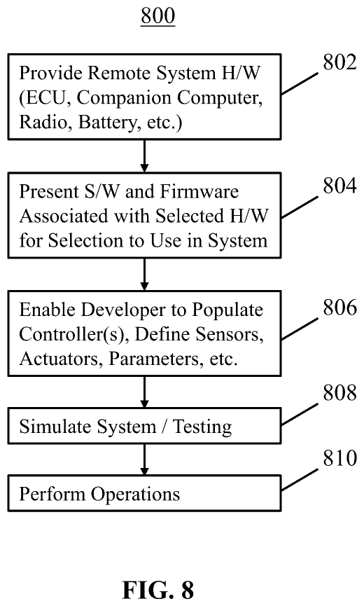

With regard to FIG. 8, a flow diagram of an illustrative process 800 for enabling a development engineer to select hardware and present software and firmware associated with the selected hardware is shown. The process 800 may start at step 802, where a provider of a rapid system development platform may provide remote system hardware (H/W), such as an electronic control unit (ECU), companion computer, radio, battery, and other circuitry on one or more printed circuit boards. The ECU and companion computer may each be formed of one or more processors. In an embodiment, in providing the remote system hardware, the provider may provide common printed circuit boards with common components or provide a number of different circuit boards with components for performing common functions (see FIG. 4A, for example). In addition to providing electronic hardware, the provider may offer common electromechanical, electro-optical, electromagnetic, and/or any other components utilized in developing remotely controlled and/or autonomously operated systems. Still yet, the provider may offer generators, gensets, solar panels, flywheels, or any other power generators and storage devices. And, because the provider may offer a specific set of components or equipment, the modules may be configured to automatically have parameters or other aspects of the modules and/or sub-modules to be set-up.

The printed circuit boards may have different processors depending on the nature of the systems in which the printed circuit boards (PCBs) are being installed. For example, systems, such as drones that need fast processing due to being relatively fast and having to manage different environmental condition, faster and more rugged processors may be utilized as compared to systems that are stationary and are immobile or move relatively slowly (e.g., transport system). Moreover, the provider may enable a development engineer to prescribe the hardware and size and shape of the printed circuitry boards to be compliant with space limitations of the systems in which the PCBs are being utilized. In an embodiment, the systems may utilize a conventional data bus, such as a controller area network (CAN) bus, which is often utilized as a vehicle bus standard designed to allow microcontrollers and devices to communicate with applications being executed on respective controllers and devices.

At step 804, the process may present software (S/W) and firmware associated with selected hardware for selection to be used in system being developed. In presenting the software and firmware, the presentation may be performed via a user interface. The software and firmware may be stored on a cloud-based server to be downloadable to an operator station and/or downloaded directly onto a system (e.g., robot), test station, emulator, and/or otherwise. The software and firmware may be modules or sub-modules that are organized into different modules that perform different functions, executed by different processors or hardware, or otherwise. The sub-modules may be pre-configured and be immediately operable, but may enable a development engineer to submit or select parameters that configure the sub-modules to operate in a manner consistent with the desired operation of the system being developed, as previously described.

At step 806, a developer may be enabled to populate controller(s), define sensors, actuators, parameters, etc. The controller(s) may be any of the processors that are operating on the system, test station, emulator, or otherwise. For example, an ECU or memory associated therewith may be loaded with firmware and/or software selected by a development engineer. Similarly, a companion computer or memory associated therewith may be loaded with firmware and/or software selected by a development engineer. If the developer is also developing a test station, test software and/or firmware may be selected and populated into the test equipment for execution during testing. The developer may also define sensors (e.g., cameras, position sensors, GPS sensors, range sensors, etc.) such that appropriate modules may be configured to capture and process data associated with the defined sensors. Likewise, actuators may also be defined by the developer. Parameters may be defined by the developer so that the modules and sub-modules are configured to control the sensors, actuators, etc. The parameters may be specific to the functions of the system, sensors, actuators, weight of system, and/or other operating conditions (e.g., responsiveness, smoothness of motion, velocity limits, acceleration limits, force limits, etc.). The parameters may be prompted to the developer via a user interface when the developer selects the respective software and/or firmware, thereby enabling the software to be downloaded with parameters set by the developer.

At step 808, a simulation and/or testing of the system may be performed. The simulation may be based on a number of input parameters defined by the developer of the system. For example, the simulation may be based on system type (e.g., UAV with fixed wings, UAV with rotary blades, land-based with wheels, land-based with tracks, stationary, etc.). In an embodiment, a simulator may enable the developer to select a specific system type, specific actuators, number of actuators, chassis, weight, aerodynamic characteristics, specific hardware (e.g., ECU, companion computer, battery size, I/O devices, etc.), simulation parameters, and so on. By providing the developer with a simulator that includes selectable system components and hardware, for example, time for development and risk of sub-optimal or failed performance of the system is significantly reduced.

In addition to a simulator, an emulator may be provided. The emulator may have or more test boards with the same or similar hardware components that are being integrated into the system so as to enable a development engineer to test software and/or hardware to be included in the system prior to being deployed in the actual system. The emulator may allow for certain functions to be tested, thereby ensuring and improving software prior to deployment into the system.

Prior to field testing, a functional test station using test equipment may enable a development engineer to test the system in a controlled environment. For example, for a UAV with rotary blades, a test cage with sensors disposed therein may be used to test stability, accuracy, flight plans, autopilots, guidance systems, imaging, range finding, and so on may be utilized.

At step 810, operations of the system may be performed. The operations may include using the system to perform real-world functions. Actual operations of the system may be performed utilizing a PCB including an ECU, companion computer, battery management unit, and radio or modem along with software and/or firmware installed with the different processors being used to drive the system. The operations may be performed after simulation, emulation, and/or testing of the system, thereby providing an operator with a reasonable sense of operational success. In performing the operations, data collection, processing, and storage utilizing the various pre-programmed resources as described herein may be utilized as an operator of the system utilizes an operator station.

With regard to FIG. 9, a block diagram of an illustrative software simulation engine (simulator) 900a and/or hardware (H/W) emulator engine (emulator) 900b configured to enable a development engineer to simulate and test hardware, software, and/or firmware selected to develop a remotely controlled and/or autonomously operated system is shown. In an embodiment, the simulation engine 900a and hardware emulator engine 900b may be in communication with one another such that certain portions of the simulation engine 900a may be executed in conjunction with certain portions of the hardware emulator engine 900b being utilized, thereby enabling a development engineer to test certain parts of hardware that are being emulated with other parts that have not yet been emulated by using the simulation engine 900a. In an alternative embodiment, the simulation engine 900a and emulator engine 900b may be independent from one another. Still yet, the simulation engine 900a may be provided without a hardware emulator engine 900b existing and the user may test the hardware in an actual system 900c or prototype thereof being developed. Such hybrid simulation/emulation enables rapid development of the system 900c. The system 900c may also be considered a device under test (DUT), where the system 900c may be a robot, drone, or other remotely controlled and/or autonomously operated system. The system 900c may be in communication with either or both of the simulation engine 900a and hardware emulator engine 900b so that either or both may provide inputs to the device under test 900c and receive outputs (e.g., operational parameters) during development or servicing (e.g., routine maintenance) thereof.

The simulation engine 900a may include a system simulator 902a to simulate portions of a system, such as the system 900c, and a scenario generator 904a configured to generate input test data to the system simulator 902a. The system simulator 902a may include an ECU simulator 906a, companion computer simulator 908a, and battery controller 910a. Each of the ECU simulator 906a, companion computer simulator 908a, and battery control simulator 910a may be formed in response to a development engineer selecting specific modules to include as part of an ECU, companion computer, and battery controller from available resources made available to the development engineer by a provider of the rapid system development kit or platform. It should be understood that other portions of the system, such as the motion management unit and modem, may be simulated, as well. The development engineer may select the modules to support specific electronic components, electrical components, electromechanical components, system mechanical components, and so on. In an alternative embodiment, each of the simulation engine 900a and emulator engine 900b may include modules that are “generic” to use as a baseline that may be modified to model a specific system.

The emulation engine 900b may include a system emulator 902b to simulate portions of a system, such as the system 900c, and a scenario generator 904b configured to generate input test data to the system emulator 902b. The system emulator 902b may include an ECU emulator 906b, companion computer simulator 908b, and battery control emulator 910a. Each of the ECU emulator 906b, companion computer emulator 908b, and battery controller emulator 910b may emulate specific modules selected to be part of an ECU, companion computer, and battery controller from available resources made available to the development engineer by a provider of the rapid system development kit or platform. It should be understood that other portions of the system, such as the motion management unit and modem, may be emulated. The development engineer may select the modules to support specific electronic components, electrical components, electromechanical components, system mechanical components, and so on. In an alternative embodiment, each of the simulation engine 900a and emulator engine 900b may include modules that are “generic” to use as a baseline that may be modified to model a specific system. The emulator engine 900b may include hardware components on which software and/or firmware may be downloaded so that testing of the actual software and/or firmware may be tested on the hardware. Moreover, once the emulator engine 900b is working, it may be possible to test portions of the system 900c that is in communication with the emulator engine 900b before the system 900c is tested on its own, as described with regard to FIG. 10.

With regard to FIG. 10, an illustration of an illustrative rapid system development platform or kit 1000 inclusive of a simulator/emulator system 1002 along with a remote system test area 1004 is shown. The simulator/emulator system 1002 and remote system test area 1004 enable a development engineer to simulate/emulate a system 1006 being developed and functionally test the system 1006 in the remote system test area 1004 in a controlled manner. The simulator/emulator 1002 may include one or more processors 1008 configured to execute software 1010 to perform simulation and/or emulation functions. The processor(s) 1008 may include one or more general processors, digital signal processors, image processors, application specific integrated circuits (ASICs), or any other processors to perform the simulation and/or emulation functionality as described herein. The simulator/emulator system 1002 may further include non-transitory memory configured to store data utilized for and/or collected from the system 1006 and/or software that is executed by the simulator/emulator 1002. An input/output (I/O) unit 1014 may be in communication with the processor(s) 1008 and be utilized to communicate data and/or control signals over local and/or non-local wired and/or wireless communications networks. A storage device 1016, such as a disk driver or other non-transitory memory, may be configured to store data repositories 1018a-1018n (collectively 1018) that store software and/or firmware that is used for simulation, emulation, and/or downloading to the system 1006.

The software and/or firmware may be downloaded from a cloud-based system that is maintained by a provider of the rapid system development platform or kit 1000. By being downloadable, version control of the software and/or firmware may be managed to support new or different hardware (e.g., ECUs). For example, if the system 1006 is local to a developer and if emulator functions are being performed, then data and/or control signals 1020 may be communicated to the system 1006 while communicatively coupled to the system 1002, which may be connected to a test and development fixture.

As further shown, an operator interface 1022 may be configured to enable an engineer developer to communicate with the system 1002. The operator interface 1022 may be a computer (e.g., laptop, tablet, remote controller, etc.), and may function to support a user interface 1024 that is used to monitor and control the system 1006. The operator interface 1022 may be used for simulation, emulation, testing, and/or operation of the system 1006. In the test and/or operation modes, the user interface 1024 may include a control section 1026 and sensor(s) section 1028. The control section 1026 may include different control parameters, both an issued command by the operator and an actual measured at the system 1006. The control parameters may include speed, orientation, heading, and so on. The control section 1026 may, of course, include control parameters that are associated with the type and configuration of the system 1006 (e.g., altitude for UAVs, depth for subsea vehicles, etc.). The sensor(s) section 1028 may include an image portion 1030 that shows images, still and/or video, captured by the system 1006, and coordinates (e.g., X, Y, Z) 1032. Other sensor data, such as temperature, battery level, and other operational or non-operational (e.g., ambient temperature, humidity, wind speed, etc.) captured by sensor(s) on the system 1006 or remote from the system 1006 may be displayed in the sensor(s) section 1028. It should be understood that alternative information may be collected and displayed for an operator during test or actual operation. Setup of the control section 1026 may be automated in response to a user submitting or selecting system type or semi-automated by providing a list of optional control parameters to be selected by a development engineer.

To control the system 1006 during testing within a remote system test area 1004, the operator station 1022 may include a number of different input devices, including a keyboard 1034a, cursor pointing device (e.g., computer mouse) 1034b, joystick 1034c, and/or virtual reality headset 1034d that may be used for controlling or otherwise interacting with the system 1006 during development, test, and/or operation of the system 1006. In an embodiment, a microphone (not shown) that supports natural language processing (NLP) to control the system to control the system 1006 may be provided. During testing of the system 1006, the simulator/emulator system and/or operator interface 1022 may be configured to communicate control signals 1036 to the system 1006 and sensor/equipment data 1038 may be communicated to the simulator/emulator system 1002 and/or operator interface 1022 for processing and/or display thereby. The control data 1036 may also be configured to communicate with equipment (e.g., local computer) and/or communicate with or be actively or passively sensed by sensors 1040a-1040n (collectively 1040) of the remote system test area 1004. The remote system test area 1004 may be an enclosed or non-enclosed area meant to enable testing of the system 1006 and/or training of operators of the system 1006. The sensors 1040 may be configured to perform distance measurements to aid in comparing system sensing 1006 and corresponding sensing (e.g., actual or relative measurements) by the sensors 1040 of the test area 1004. The sensors 1040 may be any type of sensor to enable the development engineer or other operator to test and/or operate the system 1006.

With regard to FIG. 11, a block diagram of an illustrative system architecture 1100 that supports software and firmware storage, and data flows utilizing the system architecture 1100 that are part of a rapid system development platform is shown. The system architecture 1100 may include components 1102 for use in developing systems, such as drones, robotics, Internet-of-Things (IoT), or any other remotely controlled and/or autonomously operated system. The components 1102 may include hardware, software, firmware, or otherwise, and be integrated into a system for support thereof, as previously described. Raw telemetry data sources 1104, which may be the same as the components 1102, may also be defined as part of the system architecture 1100. The raw telemetry data sources 1104 (and components 1102) may include hardware components that execute software and/or firmware may be integrated into and used to operate the systems. Moreover, the components 1102 and/or raw telemetry data sources 1104 may be integrated into an emulator or any portion of a platform that may communicate with or recharge, for example, the remotely controlled and/or autonomously operated system.

Cloud and raw data injection APIs 1106 may be utilized to support functional operation of systems, as further described herein. Providing the APIs 1106 enables a development engineer to readily deploy a system. Translation libraries 1108 may include a set of hardware and/or software translation modules (i) to support data captured from systems and (ii) to translate the captured data for presentation to an operator of the system(s), as further describe herein. Clean DC, dashboards, and administration consoles 1110 may provide user interfaces for operators, administrators, technicians, or otherwise to support systems being developed utilizing the rapid development system platform or kit, as described herein. Third-party analytics and visualization plug-ins 1112 may be provided to enable development engineers and/or operators to control and manage systems being developed utilizing the rapid system prototype development platform.

The components 1102 may include different hardware devices that optionally execute software and/or firmware that development engineers may (i) purchase from the provider of the rapid system development platform or independently thereof, and (ii) utilize in developing a remotely controlled and/or autonomously operated system. As shown, the components may include battery management and power distribution systems 1114, where the systems 1114 may be provided by the provider of the development platform or be provided by a third-party so as to be off-the-shelf or customized for use with the rapid system development platform. The components 1102 may further include propulsion and electronic speed controllers 1116 that may be utilized with developing systems, especially for systems that are configured to be self-propelled, such as UAVs, robots, or other system configured to be propelled on land, on or in sea, in air, in space, or otherwise. Real-time control logic 1118 may be provided for development engineers to acquire (e.g., purchase individually or as part of a kit or assembly). The real-time control logic 1118 may be customized or off-the-shelf and configurable by a development engineer. Real-time sensing layer and flight management unit and inertial measurement unit (FMU/IMU) hardware/software may be utilized to enable a development engineer to control a system that is airborne, mobile, sea-based, or spaced-based, for example. Other 1122 hardware and/or software systems may be utilized to support development of a system by a development engineer.

The battery management and distribution systems components 1114 may include components 1124 that support functional operations of the system to be performed and generate data of the raw telemetry data sources 1104. The components 1124 may include components from Lift Aircraft, Lithos, Power Global, and hundreds more that are viable for battery management and power distribution systems. The propulsion and electronic speed controllers 1116 may include controllers 1126 from Scorpion, T-Motor, and hundred more companies that may provide propulsion and electronic speed controllers. Each of these components 1126 may further be configured to generate data that may be communicated remotely as telemetry data. The real-time control logic 1118 may include components from Cube Pilot, Embention, PX4, Zephyr, and hundreds more. The real time sensing layer and FMU/IU components 1120 may include inertial measurement units (IMUs), GNSS/Magnetometer, optical and acoustic positioning, noise, and hundreds more different devices to perform functions that generate raw telemetry data and/or processed telemetry data. Other components 1122 may include components 1132 that support payloads and peripherals, mission planning and microclimate, and hundreds more components available to perform a wide variety of other functions for systems.

The cloud and raw data injection API 1106 may include software and/or other data for APIs for users (e.g., engineering developers, operators, etc.) 1134, equipment 1136, missions 1138, telemetry 1140, and command and control 1142. It should be understood that other cloud and raw data injection API's may be available to support rapid development of systems.

Translation libraries 1108 may be software and/or hardware and be provided as part of the rapid system development platform to be utilized to translate data collected via the API 1106 so as to be available for consoles 1110. The consoles 1110 may include consoles for users 1154, equipment 1156, missions 1158, telemetry 1160, and command and control 1162. It should be understood that additional dashboards and/or administration console may be available. For example, the consoles may further include development consoles that may be utilized during simulation, emulation, test, deployment, and/or otherwise.

The third-party analytics and visualization plug-ins 1112 may include plug-ins available from third parties other (i.e., other than the provider of the rapid system prototype platform), including app store(s) or other platform for downloadable software. Utilizing conventional app stores may provide for a more seamless experience for development engineers or operators. The plug-ins 1112 may be downloaded to a computing system, such as a desktop or laptop computer 1166a or mobile device 1166b, so as to enable display of a respective user interface 1168a or 1168b (collectively 1168). The user interfaces 1168 may include a number of different regions in which the data generated by the raw telemetry data sources 1104 and communicated to the consoles 1110 may be displayed in the different regions of the user interfaces 1168 used to enable a development engineer or operator of the system to view operational parameters or non-operational parameters of the system. The operational parameters may include any function or feature that outputs data, such as electrical data, heading data, location data, or otherwise. The non-operational data may include data related to the system, but not a functional feature of the system itself. The non-operational data may include weather data, brightness level data, terrain features, water current, water temperature, or otherwise. In an embodiment, an artificial intelligence (AI) engine 1170 may be configured in the form of a neural network of any type that is integrated into or otherwise supports at least a portion of the user interface platform and one or more of the visualization plug-ins 1112. The AI engine 1170 may be utilized to identify objects, people, or otherwise. The AI engine 1170 may be pretrained for identifying various objects or be untrained so that a development engineer may perform training of specific objects. If trained, additional training may be performed for specific objects. In response to identifying an object, such identification may be displayed on the user interface 1168 in association with identified objects. For example, if an object, such as a building, is identified, the building may be highlighted or otherwise identified on user interface 1168 to improve the ability for an operator to utilize the system. The user interface 1168 may enable a user to name dashboards at step 1172, save dashboards at step 1174, and share dashboards at step 1176.

In operation, telemetry from a system may by captured and communicated within a real-time data pipeline 1178, historic data pipeline 1180, simulation pipeline 1182, and/or emulation pipeline (not shown). The pipelines may simply mean the communication of data via a communications channel. The data may be any data that is captured and/or generated and communicated for a development engineer or operator of the system to view. In an embodiment, the pipelines may be wireless, wireless, or combination thereof, and may include communication channels over local communication channel(s) (e.g., WiFi®) or wideband area network (WAN). The pipelines 1178, 1180, and 1182 may also be utilized for utilizing the data in controlling the systems.

The foregoing method descriptions and the process flow diagrams are provided merely as illustrative examples and are not intended to require or imply that the steps of the various embodiments must be performed in the order presented. As will be appreciated by one of skill in the art, the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to and/or in communication with another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description here.

When implemented in software, the functions may be stored as one or more instructions or code on a non-transitory computer-readable or processor-readable storage medium. The steps of a method or algorithm disclosed here may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The previous description is of a preferred embodiment for implementing the invention, and the scope of the invention should not necessarily be limited by this description. The scope of the present invention is instead defined by the following claims.

What is claimed is:

1. A rapid system development platform for developing and operating a remotely controlled and/or autonomously operated system, said platform comprising:
a non-transitory storage device configured to store:
(i) a user database;
(ii) available hardware components database, including:
(a) at least one electronics control unit (ECU);
(b) at least one companion computer;
(c) at least one battery management unit;
(d) at least one motion management unit; and
(e) at least one radio configured to communicate data captured or generated by the remotely controlled and/or autonomously operated system;
(iii) a software and firmware database configured to be downloaded into a remotely controlled and/or autonomously operated system that includes at least one component provided in the available components database that utilizes software and/or firmware;
at least one cloud server configured to execute at least one application programming interface (API) pre-configured to receive data from the at least one radio; and
at least one dashboard configured to be executed on a computing device in communication with the at least one cloud server, and pre-configured to display data received via the at least one API.

2. The platform according to claim 1, further comprising at least one translation library configured to:
receive data from the at least one radio; and
translate the data to be formatted for display by the at least one dashboard.

3. The platform according to claim 1, wherein the at least one API includes at least one of users, equipment, missions, telemetry, and command and control.

4. The platform according to claim 1, further comprising a first user interface configured to enable a user to (i) select the at least one dashboard, and (ii) position the at least one dashboard on a second user interface for use during operation of the remotely controlled and/or autonomously operated system.

5. The platform according to claim 4, wherein the second user interface operates at a network operations center (NOC).

6. The platform according to claim 1, a simulation software database including a plurality of software modules configured to simulate functionality of one or more of the hardware components in the available components database.

7. The platform according to claim 1, further comprising software configured to:
determine selected types of the hardware components of (a) at least one ECU, (b at least one companion computer, (c) one motion management unit, and/or € at least one radio; and
present selectable and downloadable software and firmware associated with the determined selected hardware components for a user.

8. A remotely controlled and/or autonomously operated system, comprising:
an electronic control unit (ECU) configured to manage operations of the system;
at least one sensor;
a companion computer in electrical communication with the ECU, and configured to process signals output by the at least one sensor;
a drive management unit in electrical communication with the companion computer and configured to manage movement of the system;
a battery management system in electrical communication with the ECU, and configured to manage operations of the at least one battery;
a radio unit in electrical communication with the ECU; and
a communications bus via which the ECU, companion computer, drive management unit, battery management unit, and radio unit communicate with one another.

9. The system according to claim 8, wherein the communications bus is a controller area network (CAN) bus.

10. The system according to claim 9, wherein the ECU includes at least one processor configured to execute software and/or firmware that is pre-configured to communicate via the radio unit to an application programming interface (API) to a cloud server pre-configured to communicate with the ECU of the system.

11. The system according to claim 10, wherein the data communicated to the API includes data associated with a user of the system, and wherein the cloud server is configured to associate the data with a data repository of the user and system.

12. The system according to claim 11, wherein the data repository is accessible by a user interface pre-configured to display the data.

13. The system according to claim 10, wherein the drive management system includes at least one processor, and wherein the movement is flight of the system.

14. The system according to claim 10, wherein the at least one sensor includes a proximity sensor, and wherein the companion computer is configured to process data captured by the proximity sensor and the ECU and drive unit are configured to utilize the processed data to management the movement of the system.

15. A method of manufacturing a remotely controlled and/or autonomously operated system, said method comprising:
selecting an electronic control unit (ECU) configured to manage operations of the system;
selecting at least one sensor;
selecting a companion computer;
selecting a drive management unit;
selecting at least one battery;
selecting a battery management unit;
selecting a radio unit;
selecting at least one actuator;
assembling the ECU, at least one sensor, companion computer, drive management unit, at least one battery, battery management unit, radio unit, and at least one actuator on a chassis of the system;
selecting software and/or firmware to be executed by at least one of the ECU, companion computer, and drive management unit of the system; and
downloading the selected software and/or firmware to the at least one of the ECU, companion computer, and drive management unit to be executed thereby.

16. The method according to claim 15, wherein assembling includes assembling the ECU, companion computer, drive management unit, battery management unit, and radio unit onto a common electrical bus.

17. The method according to claim 16, wherein assembling onto a common bus includes assembling the ECU, companion computer, drive management unit, battery management unit, and radio unit onto a controller area network (CAN bus).

18. The method according to claim 15, further comprising storing a user identifier in association with the ECU or radio unit to be communicated from the system to a cloud server.

19. The method according to claim numeral 18, further comprising establishing a user account with which data associated with the identifier is to be stored.

20. The method according to claim 21, further comprising establishing at least one user interface and at least one API associated with the at least one user interface to enable data associated with the user identifier to be received, processed, and presented to a user via the at least one user interface.

21. The method according to claim 15, wherein selecting the ECU includes selecting at least one processor to be configured to perform control functions of the system by communicating with the companion computer, drive management unit, battery management unit, and radio unit.

22. A rapid system development platform configured to develop a remotely controlled and/or autonomously operated system, said system comprising:
a non-transitory device configured to store preconfigured data repositories, including: (i) a user database, (ii) equipment database, and (iii) command/control data associated with the equipment database;
a transceiver configured to communicate and receive commands and/or data with the remotely controlled and/or autonomously operated system;
at least one processor in communication with the non-transitory storage device and the transceiver, and configured to provide a user interface that enables a user to:
submit a user identifier;
select preset equipment data associated with the remotely controlled and/or autonomously operated system; and
communicate command/control signals to the remotely controlled and/or remotely operated system via the transceiver.
